(19) United States
(12) Patent Application Publication
(10) Pub. No.: US 2010/0007550 A1
(43) Pub. Date: Jan. 14, 2010

(54) Positioning apparatus for a mobile object

(75) Inventors: Kiyomi Nagamiya, Nisshin-shi (JP); Akihiro Ueda, Nagoya-shi (JP); Iwao Maeda, Nagoya-shi (JP); Norimasa Kobori, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/457,889

(22) Filed: Jun. 24, 2009

(30) Foreign Application Priority Data
Jul. 10, 2008 (JP) 2008-180667

(51) Int. Cl. G01S 1/00

(52) U.S. Cl. 342/357.02

(57) ABSTRACT

A positioning apparatus for a mobile object for measuring a position at a current time includes a GPS positioning unit for updating a GPS operation data; an INS positioning unit with a detection value for INS positioning; a speed detector for detecting speed; an error corrector for correcting an error of the detection value, the position measured by the INS positioning and the speed; and a mobile object model operation unit for calculating a mobile object model; wherein an initial position is calculated using the GPS operation data, and the mobile object model operation unit measures the position to the current time when the current time coincides with a GPS updating time; and wherein the initial position is calculated without the GPS operation data, and the mobile object model operation unit measures the position to the current time when the current time does not coincide with a GPS updating time.

### CROSS-REFERENCE TO RELATED APPLICATIONS

This patent application is based upon and claims the benefit of priority of Japanese Patent Application No. 2008-180667 filed on Jul. 10, 2008, the entire contents of which are incorporated herein by reference.

### BACKGROUND OF THE INVENTION

1. Field of the Invention

The present invention generally relates to a positioning apparatus for a mobile object. More specifically, the present invention relates to a positioning apparatus for a mobile object including a global positioning system (GPS) unit and a positioning unit by an inertial navigation system (INS).

2. Description of the Related Art

Conventionally, methods and apparatuses for detecting a position of a mobile object with a combination of carrier phase positioning by a GPS receiver and INS positioning are known as disclosed in Japanese patent publication No. 08-304092. The method and apparatus make it possible to obtain position data of the mobile object in real time in less time than an interval time for detecting the position of the mobile object by the GPS receiver.

In the method and apparatus for detecting the position of the mobile object disclosed in Japanese patent publication No. 08-304092, an acceleration bias is obtained by detecting a difference between a position by the GPS positioning value and a position by accumulation of INS sensor data at the past time point when the GPS positioning value exists. Then, speed is corrected with the acceleration bias, and position calculation is performed by integration until the calculation catches up with the current time.

More specifically, at the time of t0 when the GPS positioning data is measured, gyro angle data of the GPS positioning data at the times of (t-3) and (t-2) are loaded. If the difference between the gyro angle data at the times of (t-3) and (t-2) is within a necessary measurement accuracy (which means that the motion of the mobile object is nearly linear motion), the INS positioning data accumulated from the time of (t-3) to that of (t-2) are added to the GPS positioning data at the time of (t-3), which works out the positioning data at the time of (t-2). The acceleration bias of the INS is obtained from the difference between the INS positioning data at the time of (t-2) and the GPS positioning data at the time of (t-2). Then, an error of speed of the INS from the time of (t-3) to that of (t-2) is obtained from the acceleration bias. The speed at the time of (t-2) is corrected by adding the error of the speed of the INS or by subtracting the error of the speed of the INS. With the corrected speed at the time of (t-2), the current position at the time of t0 is obtained by accumulating moving distances until the time of t0. In this way, the real-time position of the mobile object is detected.

However, according to the configuration disclosed in the above-mentioned Japanese patent publication No. 08-304092, the correction is performed only in the linear motion. In case where the mobile object is a vehicle, for example, adequate accuracy of positioning cannot be ensured in actual running including rotational motion and so on. Also, since the correction of the acceleration bias is conducted only at the time when the GPS positioning data is updated, accuracy of positioning is insufficient due to the infrequent correction of the acceleration bias.

### SUMMARY OF THE INVENTION

Embodiments of the present invention provide a novel and useful positioning apparatus for a mobile object solving one or more of the problems discussed above.

More specifically, embodiments of the present invention provide a positioning apparatus for a mobile object positioning the mobile object in real time with a high degree of accuracy with a combination of GPS positioning and INS positioning even when the mobile object is rotating and/or even when the GPS positioning data is not being updated.

According to one aspect of the present invention, a positioning apparatus for a mobile object is provided for measuring a position of the mobile object at a current time and outputting the position of the mobile object in a predetermined outputting cycle, the apparatus including:
a GPS positioning unit to update a GPS operation data at a GPS operation data updating time in a predetermined data updating cycle to provide GPS position data of the mobile object corresponding to a first given time preceding the GPS operation data updating time by a predetermined time;
an INS positioning unit to measure INS position data of the mobile object based on a detection value for INS positioning detected by a detector for INS positioning;
a speed detector to detect a speed of the mobile object;
an error corrector to calculate a correction value of each of the detection value for INS positioning, the INS position data measured by the INS positioning unit and the speed detected by the speed detector and to correct each error of the detection value for INS positioning, the INS position data measured by the INS positioning unit and the speed detected by the speed detector using the correction value; and
a mobile object model operation unit to calculate a mobile object model based on the speed detected by the speed detector;
wherein, when the current time coincides with the GPS operation data updating time, an initial position of the mobile object corresponding to the first given time is calculated using the INS positioning unit, the speed detector and the error corrector based on the last GPS operation data, the INS position data measured by the INS positioning unit and the speed detected by the speed detector corresponding to the first given time, and the mobile object model operation unit calculates the position of the mobile object at the current time by computing the mobile object model from the first given time to the current time based on the speed detected by the speed detector using the correction value calculated by the error corrector at the first given time; and
wherein, when the current time does not coincide with the GPS operation data updating time, an initial position of the mobile object corresponding to a second given time preceding the current time by the predetermined time is calculated using the INS positioning unit, the speed detector and the error corrector based on the INS position data measured by the INS positioning unit and the speed detected by the speed detector corresponding to the second given time, and the mobile object model operation unit calculates the position of the mobile object at the current time by computing the mobile object model from the second given time to the current time based on the speed detected by the speed detector using the correction value corrected by the error corrector at the second given time.

According to another aspect of the present invention, a positioning apparatus for a mobile object is provided for measuring a position of the mobile object at a current time and outputting the position of the mobile object in a predetermined data updating cycle, the apparatus including:
a GPS positioning unit to update a GPS operation data at a GPS operation data updating time in the predetermined data updating cycle to provide GPS position data of the mobile object corresponding to a given time preceding the GPS operation data updating time by a predetermined time;
an INS positioning unit to measure INS position data of the mobile object based on a detection value for INS positioning detected by a detector for INS positioning;
a speed detector to detect a speed of the mobile object;
an error corrector to calculate a correction value of each of the detection value for INS positioning, the INS position data measured by the INS positioning unit and the speed detected by the speed detector and to correct each error of the detection value for INS positioning, the INS position data measured by the INS positioning unit and the speed detected by the speed detector using the correction value; and
a GPS operation data updating determination unit to determine whether the GPS operation data is updated at the GPS operation data updating time; and
wherein an initial position of the mobile object corresponding to the given time is calculated using the INS positioning unit, the speed detector and the error corrector based on the last GPS operation data, the INS position data measured by the INS positioning unit and the speed detected by the speed detector corresponding to the given time, and the position of the mobile object at the current time is calculated by using the INS positioning unit, the speed detector and the error corrector based on the INS position data and the speed detected by the speed detector from the given time to the current time if the GPS operation data updating determination unit determines that the GPS operation data is updated; and
wherein the position of the mobile object at the current time is calculated using the INS positioning unit, the speed detector and the error corrector based on the INS position data and the speed detected by the speed detector from the given time when the GPS operation data should be updated to the current time if the GPS operation data updating determination unit determines that the GPS operation data is not updated.

Additional objects and advantages of the embodiments are set forth in part in the description which follows, and in part will become obvious from the description, or may be learned by practice of the invention. The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is an overall configuration view of a positioning apparatus for a mobile object of an embodiment of the present invention;

FIG. 2 is a flow chart showing an example of a cooperative algorithm with GPS/INS/Wheel Speed and INS/Wheel Speed applied to error correction by a Kalman filter;

FIG. 3 is a view for explaining GPS/INS cooperative positioning operation of the positioning apparatus for a mobile object of a first embodiment;

FIG. 4 is a view for explaining a positioning operation routine when a GPS operation data has a two-second time delay;

FIG. 5 is a processing flow view showing a positioning operation of a positioning apparatus for the mobile object of the first embodiment;

FIG. 6 is a view for explaining arithmetic processing of a positioning apparatus for a mobile object of a second embodiment;

FIG. 7 is a processing flow view showing an arithmetic processing of a positioning apparatus for the mobile object of the second embodiment;

FIG. 8 is a view for explaining an operation profile determination of a positioning apparatus for a mobile object of a third embodiment;

FIG. 9 is a view for explaining another operation profile determination of a positioning apparatus for the mobile object of the third embodiment 3 different from that of FIG. 8; and

FIG. 10 is a processing flow view showing an arithmetic processing of the positioning apparatus for the mobile object of the third embodiment.

### DETAILED DESCRIPTION OF THE PREFERRED EMBODIMENTS

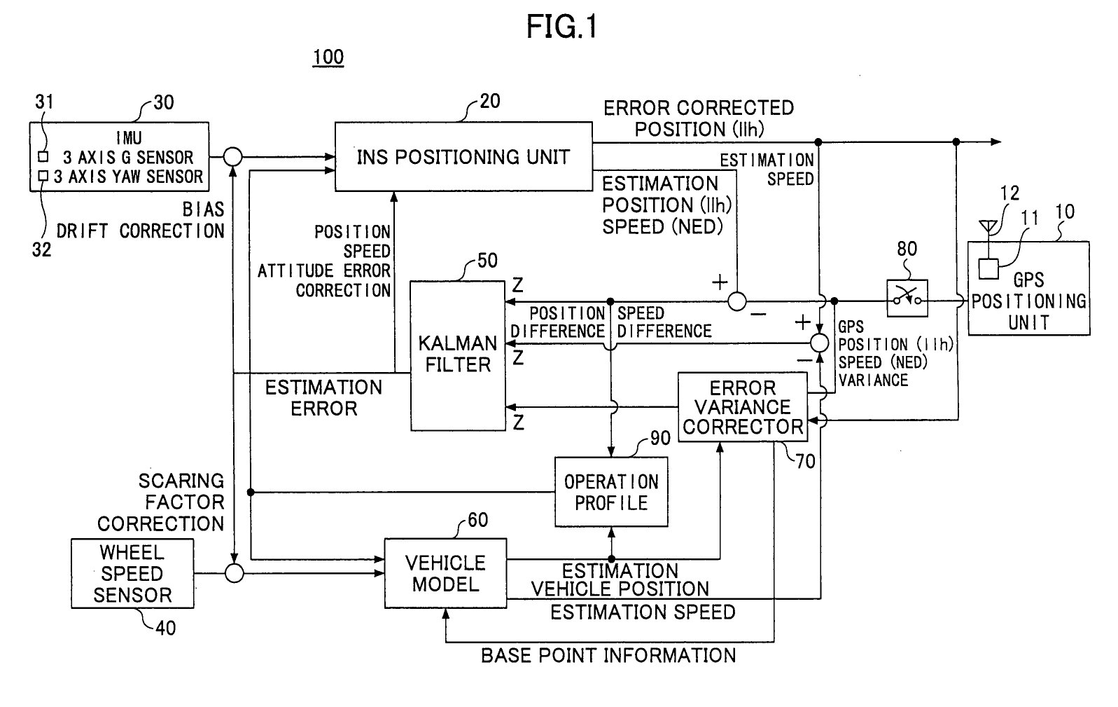

A description is given below, with reference to FIG. 1 through FIG. 10 of embodiments of the present invention.

FIG. 1 is a view showing an overall configuration of a positioning apparatus for a mobile object 100 of an embodiment of the present invention. The positioning apparatus for a mobile object 100 of the embodiment can be applied to a variety of mobile objects. For example, the positioning apparatus for a mobile object 100 can be applied to mobile objects including cars, two-wheeled motor vehicles, boats, ships, airplanes, forklifts, mobile robots and mobile terminal devices including cell-phones that move by being carried by people. In the embodiment, an example where the positioning apparatus for a mobile object 100 is applied to a vehicle is explained, but the positioning apparatus for a mobile object 100 of the embodiment can be applied to any one of the above-mentioned various mobile objects.

The positioning apparatus for a mobile object 100 of the embodiment includes a GPS positioning unit 10, an INS positioning unit 20, a detector for INS positioning 30, a wheel speed sensor 40 and a Kalman filter 50. The wheel speed sensor 40 functions as a speed detector and the Kalman filter 50 does as an error corrector. Also, the positioning apparatus for a mobile object 100 of the embodiment may include a vehicle model operation unit 60, an error variance corrector 70, a GPS operation data updating determination unit 80 and an operation profile determination unit 90, as necessary.

The GPS positioning unit 10 includes a GPS receiver 11 and a GPS antenna 12. The GPS receiver 11 of the GPS positioning unit 10 measures a vehicle position and a vehicle speed based on a satellite signal provided through the GPS antenna 12. The vehicle position and the vehicle speed may be measured by what is called a point positioning method. In this embodiment, the vehicle position and the vehicle speed are measured by a latitude-longitude-altitude coordinate system (llh and NED). Also, the GPS receiver 11 calculates error variances of the vehicle position and the vehicle speed in the process of positioning. The error variances are derived with respect to each of the coordinates including the latitude, longitude and altitude. Concerning a calculating method of the error variances, any suitable method can be adopted. The error variances calculated by the GPS positioning unit 10 are inputted into the error variance corrector 70 at a data updating cycle of the GPS operation data.

As shown in FIG. 1, the INS positioning unit 20 calculates the vehicle position and the vehicle speed and a vehicle attitude (angle of direction) based on an output signal of the detector for INS positioning 30. The detector for INS positioning 30 may be configured as, for example, an IMU (Inertial Measurement Unit) including a three-axial accelerometer 31 and a three-axial angular rate sensor 32. The measuring method of the vehicle position by the INS positioning method can vary widely and any suitable method is possible. For example, the vehicle position can be derived from an output value of the accelerometer 31. A moving distance is obtained by integrating the output value of the accelerometer 31 two times after performing a vehicle attitude conversion and a correction of gravity and Coriolis force to the output value of the accelerometer 31. Then, the vehicle position is derived by adding the moving distance to the last position value of the vehicle (feedback of the last value of the final positioning result by the positioning apparatus for the mobile object 100). In this embodiment, regarding the INS positioning unit 20, the vehicle position and the vehicle speed are obtained by the latitude-longitude-altitude coordinate system (NED).

Measuring the position by the INS positioning method with the INS positioning unit 20 sometimes results in an output error because a bias of the accelerometer 31 and a drift of the angular rate sensor 32 are integrated without modification. To correct the output error, the position and speed from the GPS positioning unit 10 and the speed from the wheel speed sensor 40 are utilized as a restraint condition. If the GPS positioning unit 10 is interrupted, only the speed from the wheel speed sensor 40 is used as a restraint condition.

A difference value of the vehicle position and vehicle speed measured by the INS positioning unit 20 (the INS tentative positioning result) to the position and speed measured by the GPS positioning unit 10 (the GPS positioning result) is calculated at the data updating cycle of the GPS operation data. The difference value is inputted into the Kalman filter 50. More specifically, the difference value of the vehicle position and the vehicle speed is inputted into the Kalman filter 50 as observable z. At this time, the difference value is obtained in a condition where the GPS positioning result and the INS tentative positioning result are synchronized in terms of time (for example, the difference value is obtained by being synchronized with a GPS time as a base time).

In a similar way, the difference value between the vehicle speed measured by the INS positioning unit 20 and an estimation vehicle speed outputted by the vehicle model operation unit 60 is obtained and inputted to the Kalman filter 50. In other words, the difference of the vehicle speed is inputted to the Kalman filter 50 as the observable z. The data updating cycle of the GPS positioning unit 10 is, for example, a second-scale interval such as 1 [second] or 2 [seconds]. However, the INS positioning unit 30 and the wheel speed sensor 40 can perform detection almost in real time. The vehicle speed outputted by the INS positioning unit 20 and the estimation vehicle speed outputted by the vehicle model operation unit 60 can be outputted at high speed such as 10 [Hz] or 20 [Hz].

The Kalman filter 50, into which the difference value of the GPS positioning result and the INS tentative positioning result is inputted, estimates an INS correction value η, a state quantity, so that the INS correction value η stochastically becomes most correct value according to reliability of each of the GPS positioning result and the INS tentative positioning result. The INS correction value η may contain not only the correction values about the vehicle position and the vehicle speed but also correction values about the vehicle attitude, the bias of the accelerometer 31 and the drift of the angular rate sensor 32. In the Kalman filter 50, for example, the INS correction value η is estimated as follows. An equation of state is set as follows.

η(tₙ)=F·η(tₙ₋₁)+G·u(tₙ₋₁)+r·w(tₙ₋₁)

In this equation, η(tₙ) represents a state variable at the time of t=tₙ. Also, u(tₙ₋₁) and w(tₙ₋₁) each represents a known input and a disturbance (system noise: normal white noise) at the time of t=tₙ₋₁. η(tₙ) may include δr(INS), an error of an estimation vehicle position r(INS), δv(INS), an error of the estimation vehicle speed V(INS) and δ ε(INS), an error of the vehicle attitude estimated by the INS positioning unit 20. η(tₙ) may also include δb, a bias error of the accelerometer 31 of the detector for INS positioning 30, δd, a drift error of the angular rate sensor 32 of the detector for INS positioning 30 and δs, a tire radius error of the vehicle.

Moreover, an observation equation is set as follows.

z(tₙ)=H(tₙ)·ƒ(tₙ)+v(tₙ)

The observable, z(tₙ), represents the difference value between the GPS positioning result and the INS tentative positioning result at the time of t=tₙ₋₁. H(tₙ) represents an observation matrix and v(tₙ) represents an observation noise.

As presented above, the Kalman filter 50 is the error corrector that estimates how much error there is in each of the INS positioning unit 20, the detector for INS positioning 30, and the wheel speed sensor 40, based on the position and speed differences between the position and speed obtained by the GPS operation data as the restraint condition and the position and speed obtained by the INS positioning, and the speed difference between the speed from the wheel speed sensor 40 as the restraint condition and the speed obtained by the INS positioning. And then the Kalman filter 50 feeds back each of these estimation errors to each of the INS positioning unit 20, the detector for INS positioning 30 and the wheel speed sensor 40 of correction objects. In the FIG. 1 embodiment, the estimation errors of the Kalman filter 50 are fed back to the INS positioning unit 20, the detector for INS positioning 30 and the wheel speed sensor 40.

The vehicle model operation unit 60 is a unit that calculates a vehicle model to estimate the vehicle position from the output of the different kinds of sensors mounted on the vehicle. A variety of ways of constructing the vehicle model are available and any way of constructing the vehicle model is possible. For example, the vehicle position may be calculated by multiplying the wheel speed by radius of the tire and by accumulating the calculation results. Hence, by further considering an angle of travel direction as an element, a mathematical formula expressing the relationship between the vehicle position and the angle of direction is possible as a way of constructing the vehicle model. The vehicle model operation unit 60 uses a model that estimates the vehicle position by estimating the moving distance of the vehicle from a base point of a known position based on the outputs of the wheel speed sensor 40. In this embodiment, the estimation vehicle position is also obtained in the latitude-longitude-altitude coordinate system (NED) by the vehicle model operation unit 60. For example, if the moving distance of the vehicle is calculated in another coordinate system such as the global fixed coordinate system based on WGS84, the estimation vehicle position can be calculated in the longitude-altitude coordinate system by transforming the coordinates of the moving distance of the vehicle and by accumulating the converted moving distance of the vehicle from the base point in the longitude-altitude coordinate system. The vehicle position estimated by the vehicle model computed by the vehicle model estimation unit 60 is inputted into the error variance corrector 70.

The error variance corrector 70 is a unit that corrects the error variance inputted from the GPS positioning unit 10. The error variance corrector 70 inputs the corrected error variance into the Kalman filter 50. In the Kalman filter 50, the state quantity (the INS correction value η) is estimated by utilizing the error variance inputted from the error variance corrector 70 as the variance of the observation noise. The error variance corrector 70 can also be equipped as desired or necessary, to correct the GPS operation data from the GPS positioning unit 10.

The GPS operation data updating determination unit 80 is a unit to determine whether the GPS operation data of the GPS positioning unit 10 is updated. The GPS receiver 11 in the GPS positioning unit 10 may not be able to receive the signal from the GPS satellite because of interferences and so on, which may cause the GPS interruption. The GPS operation data updating determination unit 80 determines whether such a GPS interruption occurs or not based on whether the GPS receiver 11 receives the signal from the GPS satellite at the data updating cycle and thereby determines whether the GPS operation data is updated.

The operation profile determination unit 90 is a unit that determines the proportion of how to distribute the GPS operation data about the vehicle position and vehicle speed from the GPS positioning unit 10, the estimation of the vehicle position and vehicle speed by the INS positioning unit 20 and the estimation of the vehicle position and vehicle speed by the vehicle model with the vehicle model operation unit 60 in order to measure the vehicle position. Because the required positioning accuracy for the mobile object varies depending on the use, an appropriate operation profile can be determined by considering the required positioning accuracy and the operation load. The operation profile determination unit 90 determines the appropriate operation profile. Since the operation profile determination unit 90 performs arithmetic processing to determine the operation profile, the operation profile determination unit 90 may be made up of a micro computer with CPU (Central Processing Unit) or an ASIC (Application Specific Integrated Circuit) for specific arithmetic processing.

A cooperative algorithm of positioning by means of the GPS positioning, the INS positioning and the wheel speed is expressed as the term “GPS/INS/WS” and a cooperative algorithm of positioning by means of the INS positioning and the wheel speed is expressed as the term “INS/WS”.

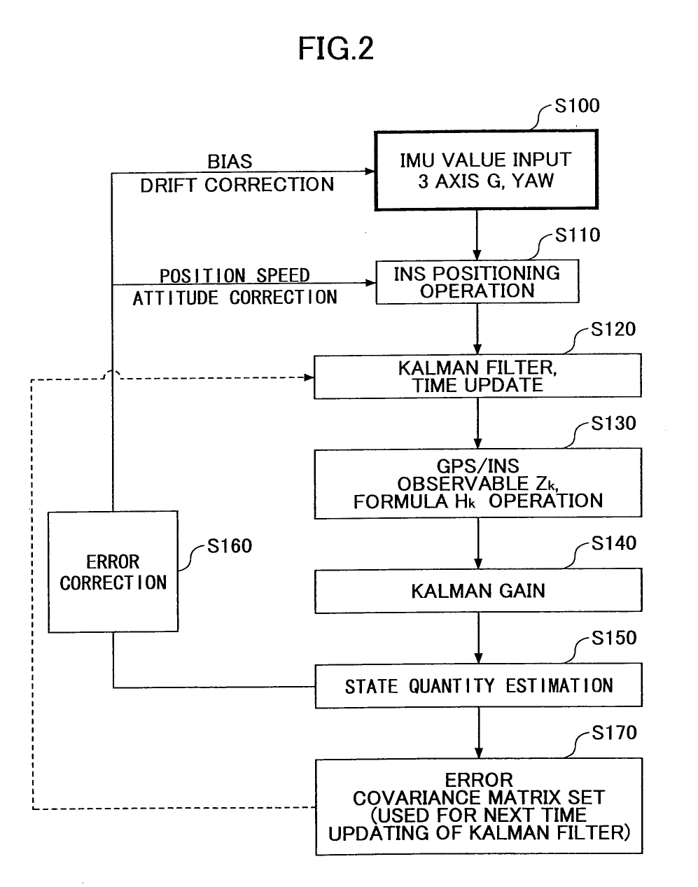

FIG. 2 is a flow chart showing an example of the cooperative algorithm by the GPS/INS/WS and the INS/WS with error correction by the Kalman filter 50, realized by the positioning apparatus for a mobile object 100 of the embodiment.

In step 100, output values of the detector for INS positioning 30 (for example, three-axial direction accelerator and three-axial angular rate) are sampled. The output values of the detector for INS positioning 30 may be corrected based on the INS correction value η estimated by the Kalman filter 50 in the following step 150. More specifically, a bias error or a drift error, the output value of the detector for INS positioning 30 may be corrected.

In step 110, in the INS positioning unit 20, the estimation vehicle position, the estimation vehicle speed, the vehicle attitude and the rest are derived from the output values of the detector for INS positioning 30 obtained in step 100.

In step 120, in the Kalman filter 50, a time updating of the Kalman filter 50 is performed. For example, the time updating of the Kalman filter 50 is expressed as follows.

η(tₙ)⁽⁻⁾=η(tₙ₋₁)⁽⁺⁾+u(tₙ₋₁)

P(tₙ)⁽⁻⁾=F·P(tₙ₋₁)⁽⁺⁾·F^{T}+Γ·Q(tₙ₋₁)·Γ^{T}

In these formulas, P represents a covariance matrix of a prediction/estimation error, and Q represents a covariance matrix (positive definite symmetric matrix) of a disturbance w. The signs (+) and (−) mean after and before the time updating.

In step 130, the observation matrix H(tₙ) is calculated based on the observable z(tₙ) of this time cycle (tₙ).

In step 140, Kalman gain Kk is calculated as follows.

K(tₙ)=P(tₙ)⁽⁻⁾·H^{T}(tₙ)·(H(tₙ)·P(tₙ)⁽⁻⁾·H^{T}(tₙ)+R(tₙ))⁻¹

In this formula, R(tₙ) represents a variance matrix of the observation noise. R(tₙ) is generated by the error variance corrector 70 as follows.

R(tₙ)=Mₖ(tₙ)·Wₖ(tₙ)

In this formula, Mₖ(tₙ) represents a matrix for updating the variance with non-diagonal elements of zero, of which default is a unit matrix. The diagonal elements of the matrix for updating the variance Mₖ(tₙ) are the gain for updating the variance. Wₖ(tₙ) is a matrix with non-diagonal elements of zero and each of the elements of the error variance (latitude element, longitude element, altitude element) calculated by the GPS positioning unit 10 is assigned to the diagonal elements of Wₖ(tₙ).

In step 150, the state quantity η(tₙ) is calculated based on the Kalman gain K(tₙ) obtained in step 140, as follows.

η(tₙ)⁽⁺⁾=η(tₙ)⁽⁻⁾+K(tₙ)·(z(tₙ)−H(tₙ)·η(tₙ)⁽⁻⁾)

In step 160, the error correction is carried out based on the state quantity η(tₙ) obtained in the above-mentioned step 150. More specifically, the correction of the bias and drift of the output values of the detector for INS positioning 30 is performed and the correction of the estimation vehicle position r(INS), the estimation vehicle speed V(INS) and the vehicle attitude is performed in the INS positioning unit 20. As a result, the estimation vehicle position and the rest after the error correction are obtained as the final positioning result (GPS/INS cooperative positioning result) of this cycle. Also, the processes of step 100 through step 170 may be repeated, for example, until the state quantity η(tₙ) converges based on the output values of the detector for INS positioning 30 of the cycle. In addition, a scaling factor (vehicle model) of the wheel speed sensor 40 may be corrected based on the estimation value of the tire radius error δs included in the state quantity η(tₙ).

By using the Kalman filter 50 of the error corrector, the GPS/INS/WS cooperative positioning result is obtained as the positioning result after the error correction when the GPS operation data exists, and the INS/WS cooperative positioning result is obtained as the positioning result after the error correction when the GPS operation data does not exist. Also, regarding the wheel speed, the value after the error correction can be obtained by using the Kalman filter 50, which makes it possible to calculate the vehicle model. These error corrections by the Kalman filter 50 are described in greater detail below.

In step 170, the covariance matrix P is updated based on the Kalman gain obtained in the above-mentioned step 140 as follows.

P(tₙ)⁽⁺⁾=P(tₙ)⁽⁻⁾−K(tₙ)·H(tₙ)·P(tₙ)⁽⁻⁾

Hereinafter, examples of the embodiment of the positioning apparatus for a mobile object 100 shown in FIG. 1 and FIG. 2 are explained.

### Embodiment 1

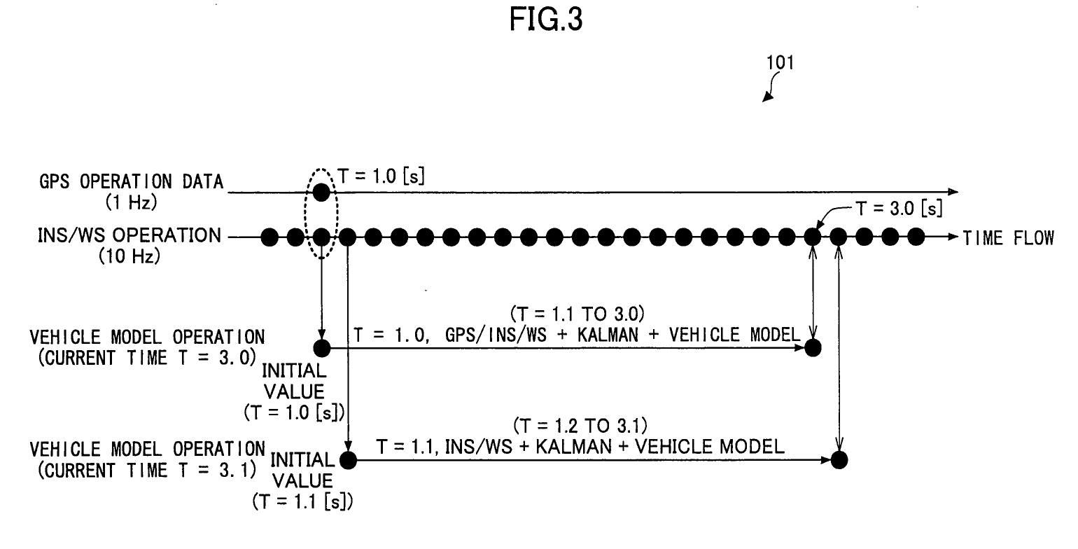

FIG. 3 is a view for explaining GPS/INS cooperative positioning by a positioning apparatus for a mobile object 101 of a first embodiment. FIG. 3 shows an operation example of the GPS/INS cooperative positioning of the positioning apparatus for a mobile object 101 of the first embodiment in time series. In the positioning apparatus for a mobile object 101 of the first embodiment, the calculation of the current position of the mobile object is performed with the mobile object model. In the overall configuration view of FIG. 1 illustrating that the mobile object is the vehicle, the positioning apparatus for a mobile object 101 of the first embodiment includes the vehicle model operation unit 60 because the positioning of the vehicle is conducted with the vehicle model operation unit 60. In the first embodiment, the error variance corrector 70, the GPS operation data updating determination unit 80 and the operation profile determination unit 90 may be omitted from the positioning apparatus for a mobile object 100, if desired.

In FIG. 3, the first line shows the data updating cycle of the GPS operation data. In the first line, the GPS operation data is updated in the data updating cycle of T=1.0 [s]. In FIG. 3, it is assumed that the GPS operation data is outputted from the positioning apparatus for the mobile object 100 with, for example, two seconds behind real time. More specifically, when the GPS operation data received and processed by the GPS positioning unit 10 is just outputted, the vehicle position of two seconds earlier is outputted, with two seconds behind.

In FIG. 3, the second line shows a time series of the INS/WS cooperative positioning operation. In the second line, the wheel speed sensor 40 and the detector for INS positioning 30 used for the INS positioning by the INS positioning unit 20 including the accelerometer 31, the angular rate sensor 32 and so on can obtain detection values almost in real time. Therefore, for example, the INS/WS cooperative positioning operation can carry out the operation in a cycle of 10 [Hz]. In FIG. 3, 20 detection values are shown from T=1.0 [s] to T=3.0 [s].

In FIG. 3, the third line is a view showing a time series of the vehicle model operation starting from T=1.0 [s] of the starting time. In the third line, the operation of the vehicle model is performed by making the time of T=1.0 [s] an initial value. As shown in the first line in FIG. 3, because the GPS operation data exists at the time of T=1.0 [s], the initial vehicle position is calculated with the result of the Kalman filter 50 of the GPS/INS/WS cooperative positioning. In a similar way, the correction of the bias and drift is performed for the acceleration and angular rate, also referred to herein as the detection vales for INS positioning. Also, the correction is performed for the wheel speed. Then, the positioning operation by the vehicle model is repeated and accumulated with the corrected detection values, and the positioning operation by the vehicle model is performed until catching up with the current time of T=3.0 [s]. By doing this, when the GPS operation data exists, the vehicle position at the current time is calculated by the vehicle model with the initial position of the GPS/INS/WS positioning.

In FIG. 3, the fourth line shows a time series of the vehicle model operation, starting from T=1.1 [s] of the initial time. In the fourth line, the operation of the vehicle model is carried out by making the time of T=1.1 [s] the starting time. However, at the time of T=1.1 [s], the GPS operation data does not exist. The data used for the INS/WS cooperative positioning does exist, though. Therefore, in this case, the initial vehicle position is calculated by utilizing the result of the Kalman filter 50 of the INS/WS cooperative positioning operation. In a similar way, the correction of the bias and drift is performed by correcting the detection values including the accelerator, angular rate, wheel speed with the result of the Kalman filter 50 of the INS/WS cooperative positioning operation. Then, the operation of the vehicle model between T=1.2 [s] and T=3.1 [s] to catch up to the current time T=3.1 [s] is conducted with the result of the Kalman filter 50 of the INS/WS cooperative positioning operation, whereby the positioning operation is executed with the vehicle model. This makes it possible to calculate the vehicle position at the current time by the vehicle model by utilizing the result of the Kalman filter 50 of the INS/WS cooperative positioning operation even though the GPS operation data does not exist.

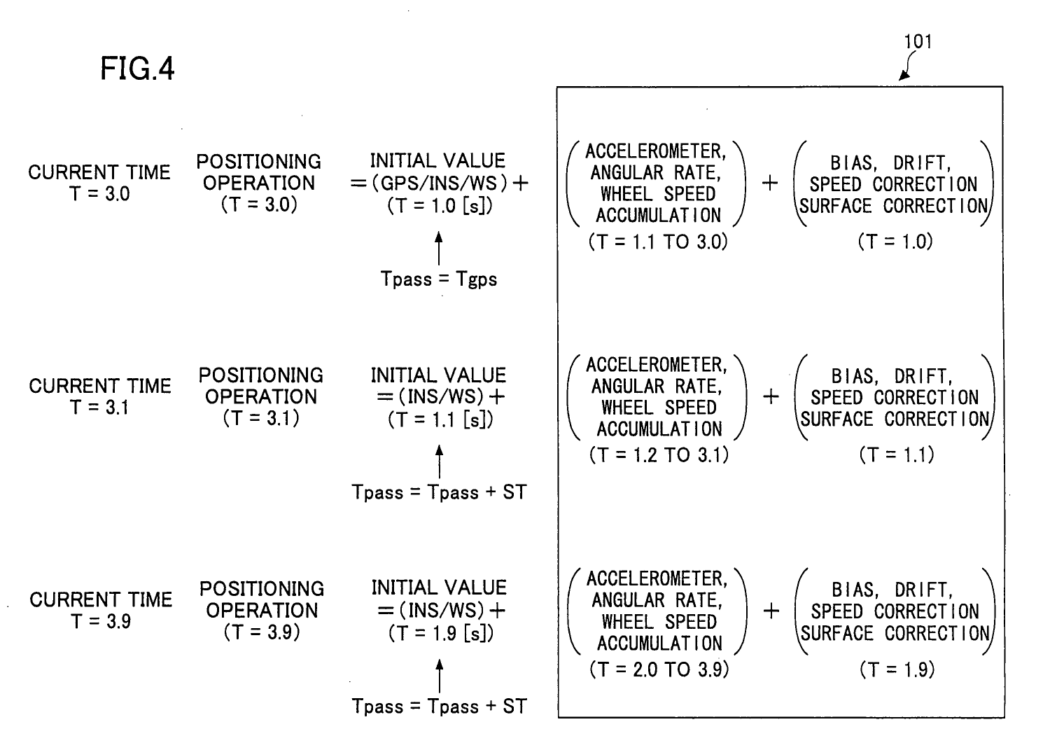

FIG. 4 is a view for explaining a positioning operation routine when the GPS operation data obtained by the GPS positioning unit 10 has, for example, a two-second delay to the actual current time. The GPS operation data is updated in a cycle of, for example, one second such as T=1.0 [s], 2.0 [s] . . . . Also, in this embodiment, the positioning apparatus for a mobile object 101 outputs the position data at T=1.1 [s], 1.2 [s], 1.3 [s] . . . and the cycle of the outputting is 0.1 [s].

The first line in FIG. 4 shows the positioning arithmetic processing when the current time is T=3.0 [s]. When the current time is T=3.0 [s], the GPS operation data is being updated for the positioning data of two seconds earlier, i.e. T=1.0 [s], and the GPS operation data exists. More specifically, if the initial time is represented as Tpass and the updating time or the GPS operation data (hereinafter, expressed as “GPS time”) is represented as Tgps, the timing is Tpass=Tgps. Therefore, in this case, the positioning data of the GPS/INS/WS cooperative positioning operation is used as the initial value. Because the vehicle position of two seconds earlier is outputted if the updated GPS operation data is outputted without change, the position change of the vehicle until the current time, i.e., the time between T=1.1 [s] and T=3.0 [s], is calculated. Since the vehicle model operation unit 60 performs the catch-up operation to calculate the vehicle position at the current time by the vehicle model, the accumulation calculation from T=1.1 [s] to T=3.0 [s] is conducted with the acceleration, the angular rate and so on including the wheel speed sensor value for calculating the vehicle model. Then, the Kalman filter 50 performs the correction of the bias corresponding to the accelerometer 31, drift corresponding to the angular rate sensor 32 and wheel speed corresponding to the wheel speed sensor 40, by using Tpass, the initial value at the time of T=1.0 [s]. Also, a mounting surface for fixing these sensors 31, 32, 40 may be corrected by the Kalman filter 50 because an improper direction of the mounting surface may cause the error of these sensors 31, 32, 40.

More specifically, because the initial time Tpass coincides with the GPS time Tgaps and because the operation data of the GPS/INS/WS cooperative positioning operation exists, the error correction value to the operation data is calculated by the Kalman filter 50 and the positioning operation by the vehicle model between T=1.1 [s] and T=3.0 [s] is conducted using the error correction value, whereby the vehicle position at the current time of T=3.0 [s] is measured.

The second line in FIG. 4 shows the positioning arithmetic processing when the current time is T=3.1 [s]. When the current time is T=3.1 [s], two seconds earlier time is T=1.1 [s] and differs from the updating timing of the GPS operation data. The initial time Tpass is the time added a cycle of the outputting cycles TS to the previous initial time shown in the first line in FIG. 4, and the initial time Tpass is calculated as follows: Tpass=Tpass+ST=Tgps+ST=1.0 [s]+0.1 [s]=1.1 [s]. In this case, because the position data does not include the operation data by the GPS/INS/WS cooperative positioning operation but just includes the positioning data by the INS/WS cooperative positioning operation, the positioning data by the INS/WS cooperative positioning operation is used as the initial value (initial position). The calculation from the initial time of T=1.2 [s] to the current time of T=3.1 [s] is performed with the sensor values of the acceleration, the angular rate and the wheel speed for computing the vehicle model as well as shown in the first line in FIG. 4. Then, the Kalman filter 50 performs the correction of the bias, drift, wheel speed and mounting surface of these detectors by using the positioning data by the INS/WS cooperative positioning operation at the time of T=1.1 [s]. Finally, the vehicle model unit 60 conducts the positioning operation by way of the vehicle model between T=1.2 [s] and T=3.1 [s] using the calculated correction values, and the positioning apparatus for a mobile position 101 measures the vehicle position at the current time of T=3.1 [s].

The third line in FIG. 4 shows the positioning arithmetic processing when the current time is T=3.9 [s]. When the current time is T=3.9 [s], the initial time Tpass becomes the time obtained by adding the outputting cycle ST to the initial time at the previous outputting cycle as well as the second line in FIG. 4 and is expressed as follows: Tpass=Tpass+ST. In the second line in FIG. 4, after the positioning data by the INS/WS cooperative positioning operation is used as the initial value and before the GPS operation data is updated at the next updating timing of T=2.0 [s], the updating data of the GPS operation data does not exist. So, the positioning by the INS/WS cooperative positioning continues. Therefore, in the third line, at the time of T=3.9 [s], the positioning data by the INS/WS cooperative positioning operation at the initial time Tpass=1.9 [s] becomes the initial value (initial position) and the Kalman filter 50 calculates the correction values of the bias, drift, wheel speed and mounting surface aspect using the initial values. Then, the positioning apparatus for a mobile object 101 corrects the acceleration, angular rate and wheel speed sensor value using the correction values, accumulates the vehicle model between T=2.0 [s] and T=3.9 [s] and outputs the vehicle position at the current time of T=3.9 [s].

As shown in FIG. 3, if the updating cycle of the GPS operation data is 1 [Hz], in other words T=1.0 [s], regarding the positioning arithmetic processing in the second line and the third line in FIG. 4, when the current time becomes T=4.0 [s] and the initial time Tpass becomes Tpass=2.0 [s], Tpass equals Tgps and the positioning arithmetic processing as explained in the first line in FIG. 4 is performed. By conducting such a series of positioning arithmetic processes, even if the positioning data obtained at the update timing of the GPS operation data shows the past vehicle position, the positioning apparatus for a mobile object 101 can measure the vehicle position at the current time with a high degree of accuracy by performing the positioning operation using the vehicle model.

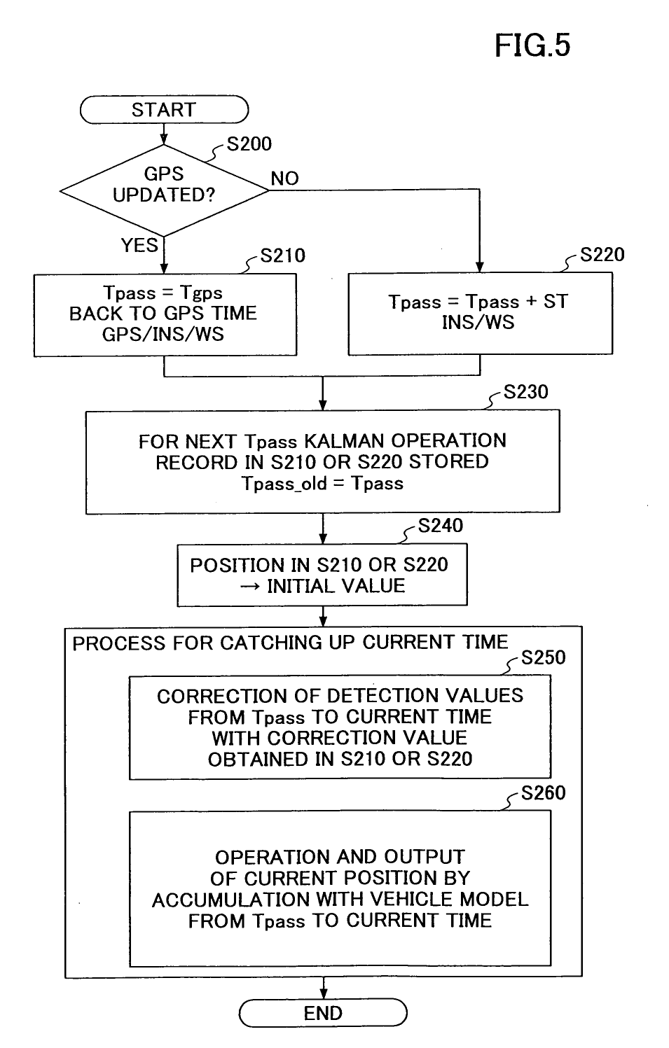

FIG. 5 is a processing flow showing a positioning arithmetic processing flow of the positioning apparatus for a mobile object 101 of the first embodiment.

In step 200, it is determined whether the GPS positioning unit 10 updates the GPS operation data. To do this, at the current time, it is determined whether the GPS operation data is updated. For example, the GPS operation data updating determination unit 80 may determine whether the GPS operation data is updated or not.

In step 200, when it is determined the GPS data is updated, the process proceeds to step 210. When it is determined that the GPS data is not updated, the process proceeds to step 220.

In step 210, the positioning apparatus for a mobile object 101 sets the GPS time Tgps as the initial time Tpass. The positioning apparatus for a mobile object 101 carry out the GPS/INS/WS cooperative positioning operation from the past GPS time, considering the time delay of the GPS, and calculates the positioning data by the GPS/INS/WS cooperative positioning operation. The positioning data may include not only the vehicle position but also the data about the vehicle speed and the vehicle attitude. The Kalman filter 50 calculates the correction values at the initial time.

In step 220, the positioning apparatus for a mobile object 101 calculates the positioning data by the INS/WS cooperative positioning operation at the initial time point Tpass=Tpass+ST, by going back the data updating cycle of the GPS operation data from the current time. The positioning data may include not only the data of the vehicle position but also the data of the vehicle speed and the vehicle attitude. Then, the Kalman filter 50 calculates the correction values at the initial time Tpass.

In step 230, the positioning apparatus for a mobile object 101 stores and leaves positioning data records including the vehicle position, the vehicle speed and the vehicle attitude calculated in step 210 or step 220 for the calculation by the Kalman filter 50 at the next initial time Tpass. A memory used for a usual RAM (Random Access Memory) may be applicable as a storage medium.

In step 240, the positioning apparatus for a mobile object 101 determines the vehicle position obtained in step 210 or step 220 as the initial value (initial position). More specifically, the positioning apparatus for a mobile object 101 sets the vehicle position obtained by either the GPS/INS/WS cooperative positioning operation or the INS/WS cooperative positioning operation at the initial time Tpass as the initial value.

In step 250, regarding the vehicle sensor values necessary for the operation of the vehicle model from the initial time Tpass to the current time, the positioning apparatus for a mobile object 100 performs the error correction with the correction values at the initial time Tpass obtained in step 210 or step 220. The vehicle sensor values may include the detection values including the accelerator, angular rate and wheel speed.

In step 260, the accumulation operation is sequentially performed by the vehicle model from the initial time Tpass to the current time by making the initial value determined in step 240 the base point and by using the correction values calculated in step 250 from the initial time Tpass to the current time. The vehicle model operation unit 60 can carry out the positioning operation by the vehicle model. The positioning apparatus for a mobile object 101 calculates and outputs the vehicle position at the current time and the processing flow finishes.

The catch-up operation performed in step 260 is executed according to the outputting cycle of the positioning apparatus for a mobile object 101. For example, if the outputting cycle of the positioning apparatus for the mobile object 101 is longer than the positioning data calculating cycle of the INS/WS cooperative positioning operation, the data outputting frequency of the INS/WS cooperative positioning operation may be decreased in accordance with the outputting cycle of the positioning apparatus for a mobile object 101.

The processing flow shown in FIG. 5 is conducted and repeated for plural outputting cycle of the positioning apparatus for a mobile object 101 of the first embodiment. In this way, according to the arithmetic processing example of the positioning apparatus for a mobile object 101 of the first embodiment, since the vehicle position at the current time is calculated by the vehicle model, the real-time positioning with a high degree of accuracy can be realized.

Moreover, according to the positioning apparatus for a mobile object 101 of the first embodiment, the positioning accuracy is ensured even when the mobile object makes movement other than linear motion because the positioning operation at the current time is performed by a mobile object model. Also, even when the current time does not coincide with the update timing of the GPS operation data, the positioning accuracy is ensured because the sensor values are corrected. In addition, because the mobile object operation unit calculates the mobile object model and measures the position of the object model at outputting cycle of the positioning apparatus for a mobile object 101, if the outputting cycle of the positioning apparatus for a mobile object 101 differs from the updating cycle of the GPS operation data, the high accuracy position can always be outputted with the mobile object model.

### Embodiment 2

A positioning apparatus for a mobile object 102 of a second embodiment is an embodiment that includes the GPS operation data updating determination unit 80, and if necessary or desired may also include the vehicle model operation unit 60, the error variance corrector 70 and the operation profile determination unit 90, for example as shown in the overall configuration view of the embodiment shown in FIG. 1.

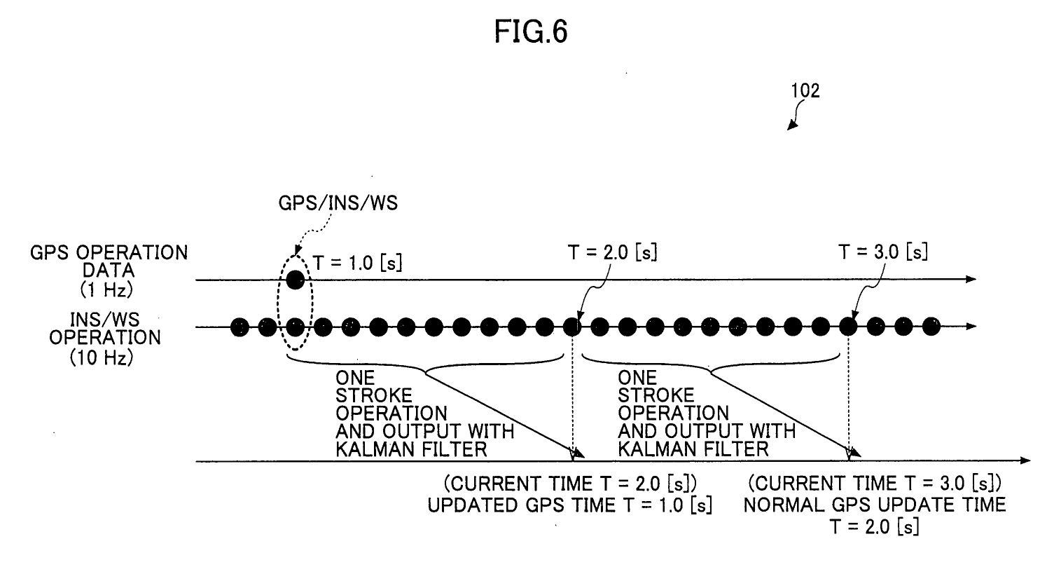

FIG. 6 is a view for explaining an example of an arithmetic processing of the positioning apparatus for a mobile object 102 of the second embodiment. In FIG. 6, a time series shows a relationship between the GPS operation data, the INS/WS cooperative positioning operation and the current time. In the second embodiment, an example of an arithmetic processing is explained by illustrating a case where the positioning outputting cycle of the positioning apparatus for a mobile object 102 corresponds to the data updating cycle of the GPS operation data of the GPS positioning unit 10. In FIG. 6, both of the data updating cycle of the GPS operation data and the positioning outputting cycle of the positioning apparatus for a mobile object 100 are T=1.0 [s] (f=1 [Hz]) and an example of performing the data updating at T=1.0 [s], T=2.0 [s], T=3.0 [s] . . . is shown.

When the time is T=1.0 [s], the GPS operation data is updated and the GPS operation data exists. The current time is T=2.0 [s]. At the time of T=1.0 [s], the positioning data of the INS/WS cooperative positioning operation exists but the GPS operation data, as above-mentioned, also exists. Therefore, at the time of T=1.0 [s], the GPS/INS/WS cooperative positioning operation is performed. Then, the Kalman filter 50 performs the error correction, which keeps the accuracy of positioning high.

In the time from T=1.1 [s] to T=2.0 [s], the GPS positioning unit 10 does not update the GPS operation data and the positioning apparatus for a mobile object 102 cannot perform the GPS/INS/WS cooperative positioning operation. However, since the positioning apparatus for a mobile object 102 can calculate the operation data of the INS/WS cooperative positioning operation, the positioning apparatus for a mobile object 102 can carry out the positioning by the INS/WS cooperative positioning operation. And in this case, the Kalman filter 50 can conduct the error correction. More specifically, in the time between T=1.1 [s] and T=2.0 [s], the positioning apparatus for a mobile object 102 can enhance the positioning accuracy by performing the INS/WS cooperative positioning operation sequentially and the correction by the Kalman filter 50 in a sampling cycle. In the first embodiment, the outputting cycle of the positioning apparatus for a mobile object 101 is so short that the detection value correction by the Kalman filter 50 can be applied only to the initial value. However, in the second embodiment, because the positioning data is calculated from the past GPS time Tgps to the current time continuously by the Kalman filter 50, the accuracy of the positioning can be maintained high. Then, the positioning apparatus for a mobile object 102 can output the positioning operation result at the current time of T=2.0 [s] in real time by using the GPS operation data at the time of T=1.0 [s].

In this way, in a case where the GPS operation data exists at the initial time, the positioning apparatus for a mobile object 102 can measure the current position by performing the GPS/INS/WS cooperative positioning operation at the initial time Tpass and then by executing the INS/WS cooperative positioning operation continuously using the Kalman filter 50 after the initial time to the current time.

In addition, the time of T=2.0 [s] is the timing of the data updating cycle of the GPS operation data, when the GPS operation data should be normally updated. However, in FIG. 6, an example where the GPS operation data is not updated at the time of T=2.0 [s] is shown. For example, there could be a case in which the vehicle is in an area where the vehicle cannot receive the signal from the satellite and the GPS positioning unit 10 is interrupted. In such a case, the GPS/INS/WS cooperative positioning operation cannot be performed at the time of T=2.0 [s], but the INS/WS cooperative positioning operation can be carried out because the vehicle sensor values for the INS/WS cooperative positioning operation exist. In this case, the positioning operation can be performed continuously from the initial time Tpass of T=2.0 [s] to the current time of T=3.0 [s] by the INS/WS cooperative positioning operation, using the correction values corrected by the Kalman filter 50. The GPS/INS/WS cooperative positioning operation cannot be applied to the initial value, but because most of the INS/WS cooperative positioning operation performed in the catch-up operation are carried out by using the corrected vehicle sensor values, the accuracy of the positioning can be maintained high.

As just described, even if the GPS interruption occurs and the GPS operation data is not updated at the data updating cycle, the position at the current time can be measured by performing the INS/WS cooperative positioning operation with the Kalman filter 50.

Whether the GPS operation data is updated at the data updating cycle may be determined by the GPS data updating determination unit 90.

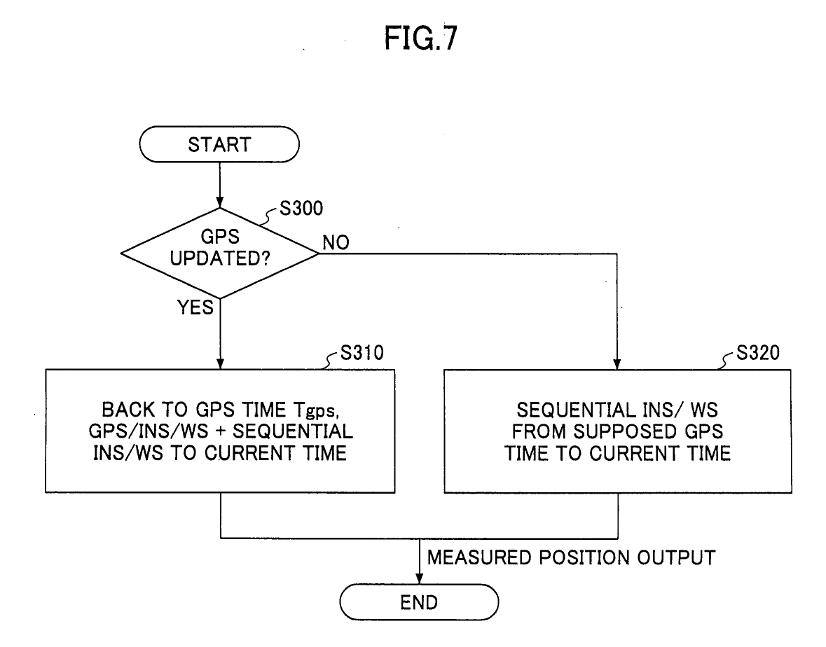

FIG. 7 is a processing flow view showing an example of the arithmetic processing of the positioning apparatus for a mobile object 102 of the second embodiment.

In step 300, it is determined whether the GPS positioning unit 10 updates the GPS operation data. The GPS operation data updating determination unit 90 may determine whether the GPS operation data is updated.

In step 300, when it is determined the GPS operation data is updated, the process proceeds to step 310. When it is determined the GPS operation data is not updated, the process proceeds to step 320.

In step 310, going back to the past GPS time Tgps, the positioning apparatus for a mobile object 102 executes the GPS/INS/WS cooperative positioning operation using the correction values corrected by the Kalman filter 50. The past GPS time Tgps, for example, corresponds to the time of T=1.0 [s]. After that, the positioning apparatus for a mobile object 102 performs the INS/WS cooperative positioning operation sequentially using the correction values corrected by the Kalman filter 50 until the current time. The positioning apparatus for a mobile object 102 sequentially carries out the INS/WS cooperative positioning operation at the sampling cycle of the vehicle sensors 31, 32, 40, accumulates the results of the INS/WS cooperative positioning operation until the current time and obtains the vehicle position at the current time. Then, the positioning apparatus for a mobile object 100 outputs the measured position at the current time and the processing flow finishes.

The processing flow shown in FIG. 7 is carried out at the positioning outputting cycle of the positioning apparatus for a mobile object 102, which corresponds to the data updating cycle of the GPS positioning unit 10. Therefore, for example, if the updating cycle of the GPS operation data of the GPS positioning unit 10 is one second, the processing flow in FIG. 7 is performed and repeated in one-second cycle.

According to the positioning apparatus for a mobile object 102 of the second embodiment, the vehicle position at the current time is measured with a high degree of accuracy. In addition, even when the GPS operation data is not updated, the positioning accuracy is ensured by correcting the detection values for INS positioning and speed of the mobile object, and by performing the positioning operation by the combination of the INS positioning and the speed of the mobile object with the corrected detection values.

### Embodiment 3

A positioning apparatus for a mobile object 103 of a third embodiment performs an arithmetic processing with a combination of the first embodiment and the second embodiment. The positioning apparatus for a mobile object 103 of the third embodiment is an embodiment that includes the vehicle model operation unit 60 and the operation profile determination unit 90 and may also include if necessary or desired the error variance corrector 70 and the GPS operation data updating determination unit 80, for example as shown in the overall configuration view of the embodiment shown in FIG. 1.

In the second embodiment, the positioning apparatus for a mobile object 102 uses the Kalman filter 50 continuously in order to ensure a real-time property in the arithmetic operation for catching up with the current time, which may increase an operation load. Considering such a situation, in the third embodiment, an example of a control to decrease the operation load and to ensure the accuracy is explained in a case where the data updating cycle of the GPS operation data corresponds to the updating cycle of the positioning apparatus for a mobile object 103 as well as the second embodiment. In the third embodiment, the positioning apparatus for a mobile object 103 performs the positioning operation whit a combination of the positioning operation by the GPS/INS/WS cooperative positioning operation, the INS/WS cooperative positioning operation and the vehicle model.

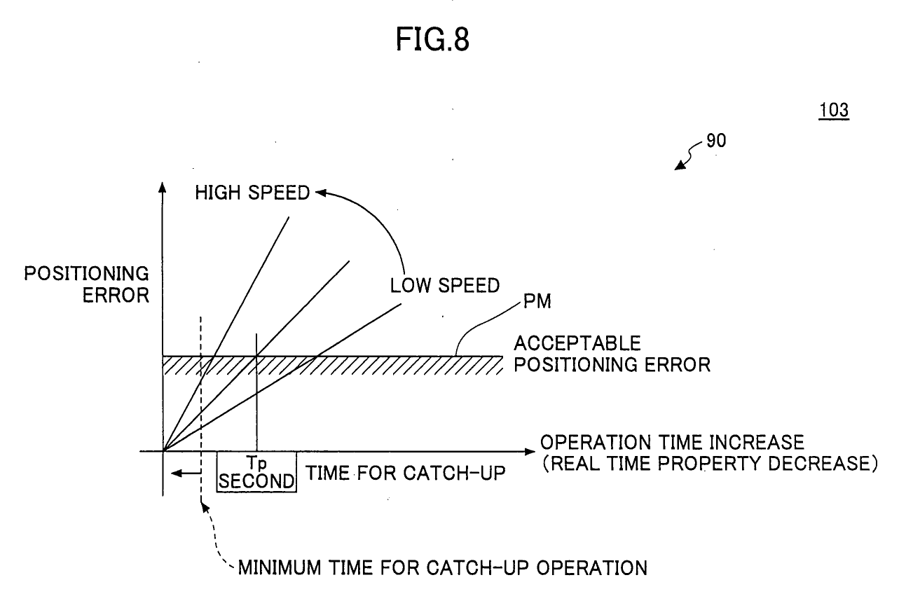

FIG. 8 is a view for explaining an example of arithmetic processing for operation profile determination executed by the operation profile determination unit 90 of the positioning apparatus for a mobile object 103 of the third embodiment. In FIG. 8, the transverse axis shows the amount of time to calculate the result of the catch-up operation to ensure the real-time property and the longitudinal axis shows the magnitude of the positioning error. The line PM drawn parallel to the transverse axis shows the magnitude of an acceptable positioning error.

In FIG. 8, for example, it is assumed that 20 times of catch-up operation is necessary. The catch-up operation has an operation time and if the operation time is too long, the real-time property may get lost. In particular, if the vehicle speed is fast, the distance that the vehicle travels per unit time becomes long, so for example, if the amount of time to make the catch-up operation becomes long, the error to the real position becomes longer. Therefore, according to the acceptable positioning error and the vehicle speed, the time to be able to allocate for the catch-up operation and the acceptable time to be able to spend for the catch-up operation vary.

In FIG. 8, if the acceptable time is assumed to be Tp second, it is noted that the Tp second moves to the left and the acceptable time becomes shorter when the vehicle speed becomes higher and the Tp second moves to the right and the acceptable time becomes longer when the vehicle speed becomes lower. If the acceptable time Tp second is distributed to the GPS/INS/WS cooperative positioning operation, the INS/WS cooperative positioning operation and the positioning operation by the vehicle model, considering number of times of the operation, the relationship may be expressed by the following formulas, (1) and (2).

A*X+B*Y+C*Z≧Tp (1)

X+Y+Z=20 (2)
A . . . INS/WS OPERATION PERIOD FOR ONE TIME
B . . . VEHICLE MODEL OPERATION PERIOD FOR ONE TIME
C . . . GPS/INS/WS OPERATION PERIOD FOR ONE TIME
X, Y, Z . . . NUMBER OF TIMES TO REPEAT EACH OPERATION

The formulas of (1) and (2) express the distribution condition expressions of the GPS/INS/WS cooperative positioning operation, the INS/WS cooperative positioning operation and the positioning operation by the vehicle model when the number of times of the operation is 20 times. “A” represents the operation period of one time by the INS/WS cooperative positioning operation and “X” represents the number of times of the INS/WS cooperative positioning operation. “B” represents the operation period of one time by the vehicle model and “Y” represents the number of times of the positioning operation by the vehicle model. “C” represents the operation period of one time by the GPS/INS/WS positioning operation and “Z” represents the number of times of the GPS/INS/WS cooperative positioning operation.

According to the formula (2), the total number of times of the operation of the X, Y and Z is 20 times and the X, Y and Z are distributed to meet the formula (1) and the operation profile is determined. Because the GPS/INS/WS cooperative positioning operation can be conducted when the current time is the updating timing of the GPS operation data and the GPS interruption does not occur, but because the GPS/INS/WS cooperative positioning operation cannot be conducted in any other cases, Z is one or zero. Because the INS/WS cooperative positioning operation includes the detection value correction by the Kalman filter 50, the accuracy of the operation is high, but the processing load is heavy and the operation time becomes long in most cases. On the other hand, in most cases, the positioning operation by the vehicle model tends to have less accuracy than the INS/WS cooperative positioning operation because the positioning operation by the vehicle model does not perform individual correction every operation, but the positioning operation by the vehicle model tends to have less processing load and less operation time than those of the INS/WS cooperative positioning operation. The processing load and the operation time depend on the setup vehicle model, but setting such a vehicle model is sufficiently possible and common. Therefore, in general, A and B tend to become B<A in most cases. Considering such conditions, in order to realize the high-accuracy positioning as much as possible and to limit the positioning operation in the acceptable time Tp, a setting to maximize X should be conducted in a range of meeting (1) formula. By doing this, the positioning can be performed with the highest accuracy in a range of the acceptable time Tp.

In addition, after X is established, it should be determined when the INS/WS cooperative positioning operation is conducted in the 20 times operation. With regard to this point, X may be distributed as many as possible at the timing when the vehicle sensor values change widely. More specifically, the state where the vehicle sensor values such as the acceleration, the angular rate, the wheel speed vary widely means a state where a vehicle behavior is wide and the error is likely to accumulate in the vehicle model. Therefore, at the timing, it is preferable that the INS/WS cooperative positioning operation is performed as high accuracy as possible and the positioning accuracy is kept high.

The vehicle sensor values may include sensor values of a steering angle, hydraulic pressure of a brake, accelerator pedal and so on as well as the above-mentioned acceleration, angular rate and wheel speed. Because a wide vehicle behavior includes large circling and rapid acceleration and deceleration, a state where the vehicle behavior is wide is detected by the steering angle, pressure of the brake, accelerator pedal and so on.

The operation shown in FIG. 8 and formulas (1) and (2) can be conducted by the operation profile determination unit 90. Also, for example, whether the vehicle behavior is wide may be determined by the operation profile determination unit 90 based on the vehicle sensor values. For example, if the sensor values are more than predetermined values, the operation profile determination unit 90 may determine that the vehicle behavior is wide.

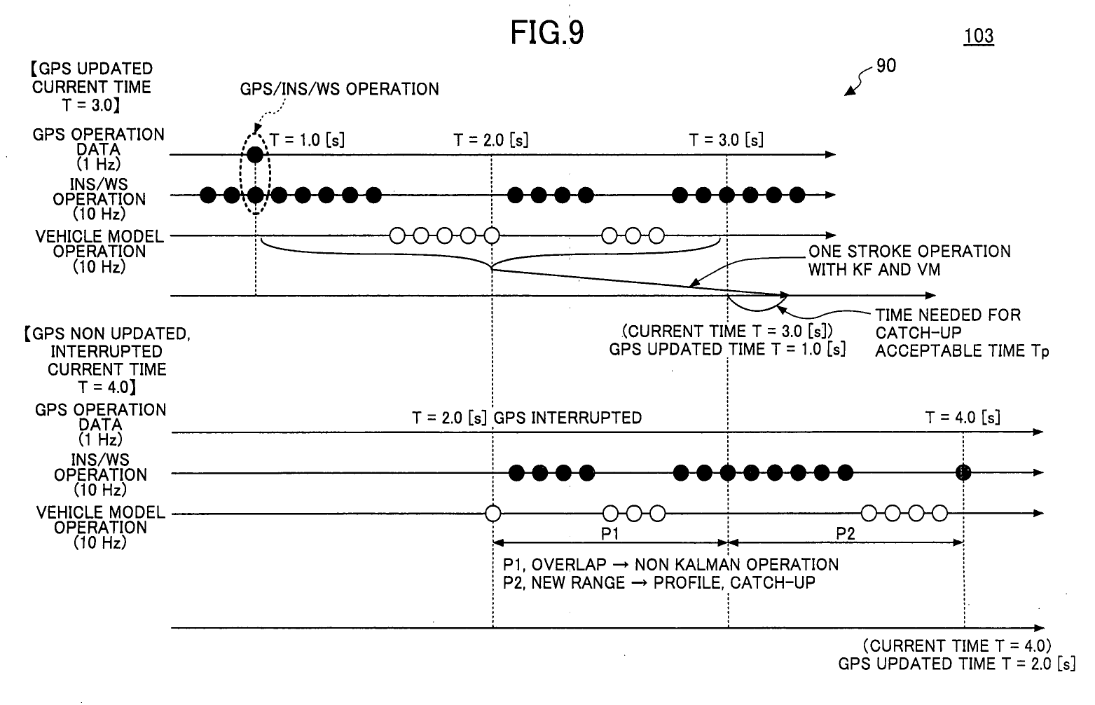

Next, an example of the arithmetic processing of the operation profile determination different from FIG. 8 is explained. The arithmetic processing of the operation profile determination is performed by the operation profile determination unit 90. FIG. 9 is a view for explaining the example of the arithmetic processing of the operation profile determination different from FIG. 8.

The upper part in FIG. 9 shows a time series in a case where the GPS operation data indicates the vehicle position of two seconds ago and the vehicle position at the current time of T=3.0 [s] is being outputted. In the upper part in FIG. 9, at the time of T=1.0 [s], the GPS operation data is updated and the GPS operation data exists. Hence, at the initial time of Tpass=1.0 [s], the positioning apparatus for a mobile object 103 carries out the GPS/INS/WS cooperative positioning operation. After that, according to the operation profile explained in FIG. 8, until the current time of T=3.0 [s], the INS/WS cooperative positioning operation by Kalman filter 50 and the positioning operation by the vehicle model are calculated continuously and the result is outputted. At this time, as shown in the upper part of FIG. 9, a little delay is acceptable as long as the delay is within the acceptable time Tp.

The lower part in FIG. 9 shows a series time of the arithmetic processing in a case where the vehicle position is outputted at the current time of T=4.0 [s]. The lower part in FIG. 9 shows a case where the GPS interruption occurs and the GPS operation data is not updated at the time of T=2.0 [s], when the GPS data should be being normally updated because the data updating cycle of the GPS operation data is 1 [Hz], in other words T=1.0 [s].

In such a case, in the above described embodiments, i.e. the first and second embodiments, the catch-up operation until the current time of T=4.0 [s] is performed by making the positioning data at the time of T=2.0 [s] the initial value. However, the upper part and lower part in FIG. 9 shows the same operation profile between T=2.0 [s] and T=3.0 [s]. In this case, the positioning operation by the Kalman filter is not conducted in a range of P1 because the operation profile in the range of P1 in the lower part in FIG. 9 overlaps with the operation profile executed at the current time of T=3.0 [s] in the upper part in FIG. 9. Then, the operation profile is made up over a range of P2, between T=2.0 [s] and T=3.0 [s], and the catch-up operation is carried out. By doing this, regarding the operation profile that overlaps with the already calculated operation profile when the positioning data is outputted at the previous outputting cycle, the positioning apparatus for a mobile object 103 can omit the arithmetic processing and lessen the arithmetic processing load.

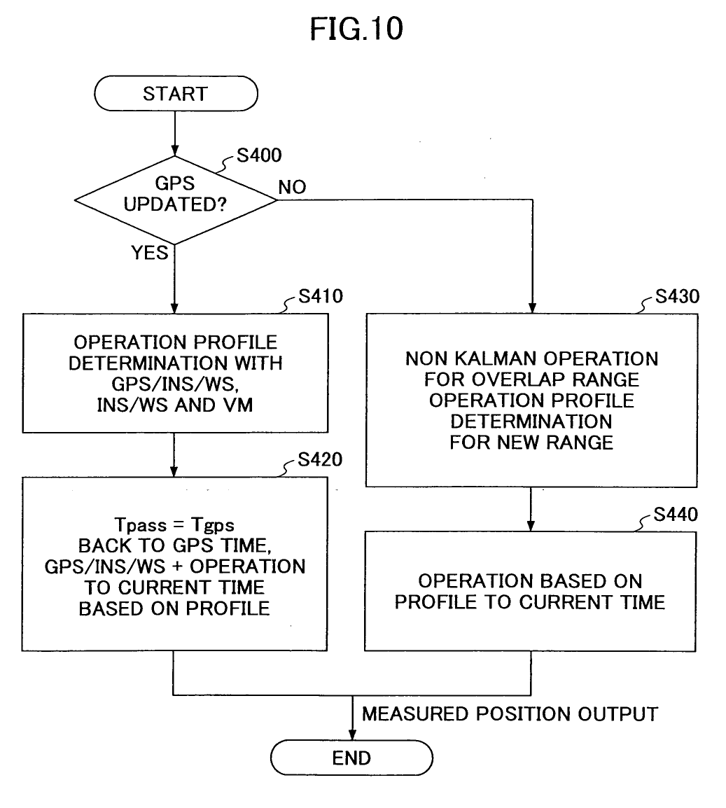

Next, a processing flow of the positioning apparatus for a mobile object 103 of the third embodiment is explained with respect to FIG. 10. FIG. 10 is a processing flow view of an arithmetic processing conducted by the positioning apparatus for a mobile object 103 of the third embodiment.

In step 400, whether the GPS data is updated is determined. The determination of whether the GPS operation data is updated, for example, may be performed by the GPS operation data updating determination unit 80.

In step 400, if the GPS operation data is updated, the process proceeds to the step 410.

In step 410, the operation profile determination unit 90 determines the operation profile that decides how to distribute the GPS/INS/WS cooperative positioning operation, the INS/WS cooperative positioning operation and the vehicle model positioning operation. As explained in FIG. 8, the operation profile may be determined by using the operation formulas of (1) and (2) if needed or desired, considering the acceptable time Tp spent for the catch-up operation, the required positioning accuracy, the processing load and so on.

In step 420, because the initial time Tpass corresponds to the GPS time Tgps, which means Tpass=Tgps, the positioning apparatus for a mobile object 103 goes back to the past GPS time Tgps and performs the GPS/INS/WS cooperative positioning operation. After that, according to the operation profile determined in step 410, the positioning apparatus for a mobile object 103 sequentially conducts the positioning operation until the current time and obtains the current position. Then, the positioning apparatus for a mobile object 103 outputs the measured position and the processing flow finishes.

On the other hand, returning to step 400, if it is determined the GPS operation data is not updated and the GPS is interrupted, the process advances to step 430.

In step 430, the operation profile is determined by the operation profile determination unit 90, but, as explained in the lower part of FIG. 9, regarding the range overlapping with the operation at the previous outputting cycle, the operation with the Kalman filter 50 is not carried out. Concerning the range that does not overlap with the operation at the previous outputting cycle, the operation profile determination unit 90 determines the operation profile of how to distribute the INS/WS cooperative positioning operation and the vehicle model positioning operation.

In step 440, according to the operation profile determined in step 430, the positioning apparatus for a mobile object 103 sequentially performs the positioning operation until the current time and obtains the current position. Then, the positioning apparatus for a mobile object 103 outputs the measured position and the processing flow finishes.

The processing flow in FIG. 9 is repeated in the outputting cycle of the positioning apparatus for a mobile object 103 and in the data updating cycle.

According to the positioning apparatus for a mobile object 103 of the third embodiment, the real-time position of the mobile object can be measured with the operation profile determination unit 90, considering both of the arithmetic processing load and the positioning accuracy, thereby ensuring the positioning accuracy and reducing the operation load. Also, the positioning accuracy can be set according to application. In addition, when the behavior of the mobile object is wide, the ratio of accurate operation is more distributed to the widely changing sensor values and thereby the positioning accuracy can be ensured even if the positioning tends to be inaccurate.

As described in the embodiments, the positioning apparatus for a mobile object 100, 101, 102, 103 can detect the errors of a variety of detectors by the Kalman filter 50 and enhance the accuracy of the positioning operation by properly correcting the errors. Also, according to the embodiments, it is possible to provide a navigation system for a vehicle with high accuracy and real-time property, which can accurately indicate the current vehicle position to a user.

In the embodiments of FIG. 1 and FIG. 2 and the embodiments 1-3, examples of arithmetic processing where the positioning apparatus for a mobile object 100, 101, 102, 103 is applied to the vehicle. However, if the wheel speed is applied to the speed of the mobile object and the vehicle model is applied to the mobile object model, the present invention may be applied to a variety of mobile objects.

Thus, according to the embodiments of the present invention, it is possible to provide a positioning apparatus for a mobile object whereby a position of the mobile object in real time at the current time is measured with a high degree of accuracy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that the various changes, substitutions, and alterations could be made hereto without departing from the spirit and scope of the invention.

What is claimed is:

1. A positioning apparatus for measuring a position of a mobile object at a current time and outputting the position of the mobile object in a predetermined outputting cycle, the apparatus comprising:
a GPS positioning unit to update a GPS operation data at a GPS operation data updating time in a predetermined data updating cycle to provide GPS position data of the mobile object corresponding to a first given time preceding the GPS operation data updating time by a predetermined time;
an INS positioning unit to measure INS position data of the mobile object based on a detection value for INS positioning detected by a detector for INS positioning;
a speed detector to detect a speed of the mobile object;
an error corrector to calculate a correction value of each of the detection value for INS positioning, the INS position data measured by the INS positioning unit and the speed detected by the speed detector and to correct each error of the detection value for INS positioning, the INS position data measured by the INS positioning unit and the speed detected by the speed detector using the correction value; and
a mobile object model operation unit to calculate a mobile object model based on the speed detected by the speed detector;
wherein, when the current time coincides with the GPS operation data updating time, an initial position of the mobile object corresponding to the first given time is calculated using the INS positioning unit, the speed detector and the error corrector based on the last GPS operation data, the INS position data measured by the INS positioning unit and the speed detected by the speed detector corresponding to the first given time, and the mobile object model operation unit calculates the position of the mobile object at the current time by computing the mobile object model from the first given time to the current time based on the speed detected by the speed detector using the correction value calculated by the error corrector at the first given time; and
wherein, when the current time does not coincide with the GPS operation data updating time, an initial position of the mobile object corresponding to a second given time preceding the current time by the predetermined time is calculated using the INS positioning unit, the speed detector and the error corrector based on the INS position data measured by the INS positioning unit and the speed detected by the speed detector corresponding to the second given time, and the mobile object model operation unit calculates the position of the mobile object at the current time by computing the mobile object model from the second given time to the current time based on the speed detected by the speed detector using the correction value corrected by the error corrector at the second given time.

2. The positioning apparatus for the mobile object as claimed in claim 1,
wherein, the mobile object model operation unit calculates the mobile object model and the position of the mobile object in the predetermined outputting cycle.

3. A positioning apparatus for measuring a position of a mobile object at a current time and outputting the position of the mobile object in a predetermined data updating cycle, the apparatus including:
a GPS positioning unit to update a GPS operation data at a GPS operation data updating time in the predetermined data updating cycle to provide GPS position data of the mobile object corresponding to a given time preceding the GPS operation data updating time by a predetermined time;
an INS positioning unit to measure INS position data of the mobile object based on a detection value for INS positioning detected by a detector for INS positioning;
a speed detector to detect a speed of the mobile object;
an error corrector to calculate a correction value of each of the detection value for INS positioning, the INS position data measured by the INS positioning unit and the speed detected by the speed detector and to correct each error of the detection value for INS positioning, the INS position data measured by the INS positioning unit and the speed detected by the speed detector using the correction value; and
a GPS operation data updating determination unit to determine whether the GPS operation data is updated at the GPS operation data updating time; and
wherein an initial position of the mobile object corresponding to the given time is calculated using the INS positioning unit, the speed detector and the error corrector based on the last GPS operation data, the INS position data measured by the INS positioning unit and the speed detected by the speed detector corresponding to the given time, and the position of the mobile object at the current time is calculated by using the INS positioning unit, the speed detector and the error corrector based on the INS position data measured by the INS positioning unit and the speed detected by the speed detector from the given time to the current time if the GPS operation data updating determination unit determines that the GPS operation data is updated; and
wherein the position of the mobile object at the current time is calculated using the INS positioning unit, the speed detector and the error corrector based on the INS position data measured by the INS positioning unit and the speed detected by the speed detector from the given time when the GPS operation data should be updated to the current time if the GPS operation data updating determination unit determines that the GPS operation data is not updated.

4. The positioning apparatus for the mobile object as claimed in claim 3,
wherein, the apparatus further comprises:
a mobile object model operation unit to calculate a position of the mobile object by using a mobile object model based on the speed of the mobile object, and
an operation profile determination unit to determine an operation profile of a first positioning operation by the INS positioning unit, the speed detector, the error corrector using the GPS operation data, a second positioning operation by the INS positioning unit, the speed detector and the error corrector and a third positioning operation by the mobile object model.

5. The positioning apparatus for the mobile object as claimed in claim 4,
wherein the operation profile determination unit determines the operation profile except by the third positioning operation by the mobile object model when a behavior of the mobile object is determined to be wide.

6. The positioning apparatus for the mobile object as claimed in claim 1,
wherein the error corrector includes a Kalman filter.

7. The positioning apparatus for the mobile object as claimed in claim 1,
wherein the mobile object is a vehicle and the speed of the mobile object is represented by a wheel speed of the vehicle.
